(19) United States
(12) Patent Application Publication
(10) Pub. No.: US 2026/0113388 A1
(43) Pub. Date: Apr. 23, 2026

(54) SYSTEM AND METHOD FOR DYNAMIC REDUNDANCY-AWARE BLOCKCHAIN-BASED PARTIAL COMPUTATION OFFLOADING FOR METAVERSE WITHIN COMPUTING ENVIRIONMENT IN NETWORK

(71) Applicant: INDUSTRY FOUNDATION OF CHONNAM NATIONAL UNIVERSITY, Gwangju (KR)

(72) Inventors: Jinsul KIM, Gwangju (KR); Ibrahim ALIYU, Gwangju (KR); Sangwon OH, Gwangju (KR); Jihoon LEE, Gwangju (KR); Junghoon LEE, Gwangju (KR)

(73) Assignee: INDUSTRY FOUNDATION OF CHONNAM NATIONAL UNIVERSITY, Gwangju (KR)

(21) Appl. No.: 19/423,673

(22) Filed: Dec. 17, 2025

Related U.S. Application Data
(63) Continuation of application No. PCT/KR2024/021269, filed on Dec. 27, 2024.

(30) Foreign Application Priority Data
Dec. 29, 2023 (KR) 10-2023-0196004

(51) Int. Cl. H04L 67/59; H04L 9/00

(52) U.S. Cl. CPC H04L 67/59; H04L 9/50

(57) ABSTRACT

Provided is a system and a method for a dynamic redundancy-aware blockchain-based PCO for Metaverse within a COIN environment. The system includes user equipment that transmits a request for a task of the Metaverse, and a COIN device that operates a service of the Metaverse service. The COIN device includes a plurality of layers, and a controller that calculates a PCO and sends a request for determining a layer that performs a Metaverse task requested by the user equipment.

### CROSS-REFERENCE TO RELATED APPLICATIONS

The present application is a continuation of International Patent Application No. PCT/KR2024/021269, filed on Dec. 27, 2024, which is based upon and claims the benefit of priority to Korean Patent Application No. 10-2023-0196004 filed on Dec. 29, 2023. The disclosures of the above-listed applications are hereby incorporated by reference herein in their entirety.

### BACKGROUND

Embodiments of the present disclosure described herein relate to a method and a system for optimizing offloading for applications and services in an in-network computing environment.

Metaverse-based services provide users with immersive experiences based on technologies such as Virtual Reality (VR) and Augmented Reality (AR).

However, these metaverse-based services have various limitations when applying user equipment (UE) or mobile edge computing (MEC).

Network optimization techniques for allocating network resources of metaverse services are important for ensuring user security while simultaneously ensuring network performance that satisfies the Quality of Service (QoS) required to operate metaverse services.

In contrast, the paradigm of COmputing In Network (COIN) minimizes network latency and optimizes user immersive experiences by utilizing network resources with low actual utilization rates. However, as the usage of the COIN increases, power consumption increases nonlinearly, and thus the need to optimize this is essential for building metaverse services.

A blockchain provides privacy and secure communication for distributed data, but complete data redundancy leads to scalability issues such as high storage demands, which impacts data decentralization.

For example, the blockchain of Bitcoin requires approximately 10,000 nodes for approximately 4.6 PG of storage to secure over 477 GB.

Accordingly, resolving data redundancy in network environments involves complex optimization problems that consider blockchain costs, mining incentives, and the costs of decentralization and offloading, necessitating efficient computation offloading to calculate these.

### SUMMARY

Embodiments of the present disclosure provide a system and a method for a dynamic redundancy-aware blockchain-based partial computation offloading for a metaverse within a COIN environment.

According to an embodiment, a dynamic redundancy-aware blockchain-based Partial Computation Offloading (PCO) system for Metaverse in a COmputing In Network (COIN) environment includes user equipment that transmits a request for a task of the Metaverse, and a COIN device that operates a service of the Metaverse. The COIN device includes a plurality of layers, and a controller that calculates a PCO and sends a request for determining a layer that performs a Metaverse task requested by the user equipment.

In this case, the plurality of layers may include a first layer that receives user data including a task request sent from the user equipment, and performs first task offloading or sends the user data to a Metaverse service network.

Moreover, the plurality of layers may further include a second layer that receives the user data including the task request through the first layer, and performs the first task offloading or the PCO.

Furthermore, the plurality of layers may further include a third layer that ensures the stability of data including a user request and guarantees privacy so as to identify an offloading policy for determining the PCO, and whether redundancy is recognized.

Also, the user equipment may perform a function of connecting to a Metaverse service built based on the COIN environment, and a function of transmitting a request for a Metaverse task and sub-tasks to a server and a network in the Metaverse service.

Besides, the controller may perform a function of preemptively determining a redundancy factor of a blockchain to determine an offloading method, a function of defining policies of the Metaverse task, a function of measuring the redundancy factor of a blockchain where the requested Metaverse task is stored, and a function of controlling remote task commands within the system.

In addition, the first layer may include a base station that receives the user data transmitted from the user equipment, a COIN node capable of data communication with the controller or the base station, and a cloudlet that performs the first task offloading, and may be capable of abstract or generalization.

Moreover, the COIN node may include a function of receiving an offloading command from the controller, and delivering the PCO according to the user data, and a function of transmitting data based on a user request to the cloudlet, and may be a node for a physical network device or a virtualized system.

Furthermore, the cloudlet may include a function of performing a Metaverse service request sent from the respective user device, and may be a physical computation/storage device or a virtual machine-based system capable of complex computation.

Also, the second layer may include a COIN node capable of data communication with the controller or the first layer and a cloud data center capable of performing the first task offloading, and may be a network layer capable of abstract or generalization.

Besides, the COIN node may perform a function of receiving an optimal offloading command from the controller and delivering an optimal PCO according to the user data to the user equipment, and a function of transmitting data based on a user request to the cloud data center.

In addition, the cloud data center may be a high-spec virtual machine-based system or a physical computation/storage device capable of complex computation that performs a request of a Metaverse task sent from pieces of user equipment.

Moreover, the third layer may be a network layer having, as components, a plurality of distributed databases that perform a function of encrypting the user data including a Metaverse task request of the user equipment, and a function of storing a transaction for a request of the user equipment.

According to an embodiment, a dynamic redundancy-aware blockchain-based PCO method for Metaverse in a COIN environment includes receiving a request for a task of the Metaverse from user equipment, calculating a PCO through a plurality of layers, and determining a layer that performs a Metaverse task requested by the user equipment.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of a dynamic redundancy-aware blockchain-based PCO system for Metaverse in a COIN environment, according to an embodiment of the present disclosure;

FIG. 2 is a diagram for describing a distributed algorithm proposed to solve a PCO problem modeled in a form of an ODG that allows multi-users to connect on a user side, according to an embodiment of the present disclosure;

FIG. 3 is a diagram illustrating an algorithm for training a DQN, according to an embodiment of the present disclosure;

FIG. 4 is a flowchart illustrating an operating mechanism for each time slot in a system, according to an embodiment of the present disclosure;

FIG. 5 is a diagram for describing an interaction between an algorithm and a system model, according to an embodiment of the present disclosure;

FIG. 6 is a diagram showing the progress of system cost and system reward for iteration steps according to various episodes, according to an embodiment of the present disclosure;

FIG. 7 is a diagram for comparing a reward function based on an average cost with OPG and OPG-Rand agents, according to an embodiment of the present disclosure;

FIG. 8 is a diagram for comparing and describing impacts of computing task types on computational overhead according to an embodiment of the present disclosure, for each of average cost, average delay, and average reward;

FIG. 9 is a diagram for comparing and describing the impact of the maximum redundancy factor for each time slot with respect to each of the average cost and average reward, according to an embodiment of the present disclosure; and

FIG. 10 is a diagram for describing an evaluation of the performance of each time slot for a set of various numbers of users according to an average cost and an average reward, according to an embodiment of the present disclosure.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, a ‘device according to an embodiment of the present disclosure’ includes all various devices capable of providing results to a user by performing arithmetic processing. For example, the device according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Functions related to artificial intelligence according to an embodiment of the present disclosure are operated through a processor and a memory. The processor may consist of one or more processors. In this case, the one or more processors may be a general-purpose processor (e.g., a CPU, an AP, or a digital signal processor (DSP)), a graphics-dedicated processor (e.g., a GPU or a vision processing unit (VPU)), or an artificial intelligence (AI)-dedicated processor (e.g., an NPU). Under control of the one or more processors, input data may be processed depending on an AI model, or a predefined operating rule stored in the memory. Alternatively, when the one or more processors are AI-dedicated processors, the AI-dedicated processor may be designed with a hardware structure specialized for processing a specific AI model.

The predefined operating rule or the artificial intelligence model is created through learning. Here, being created through learning means creating the predefined operating rule or the artificial intelligence model configured to perform desired features (or purposes) as a basic artificial intelligence model is learned by using pieces of learning data by a learning algorithm. This learning may be performed by a device itself, on which the artificial intelligence according to an embodiment of the present disclosure is performed, or may be performed through a separate server and/or system. For example, the learning algorithm may include supervised learning, unsupervised learning, semi-supervised learning, or reinforcement learning, but may not be limited to the above example.

An artificial intelligence model may be composed of a plurality of neural network layers. The plurality of neural network layers respectively have a plurality of weight values, and each of the plurality of neural network layers performs neural network calculation through calculations between the calculation result of the previous layer and the plurality of weight values. The plurality of weight values of the plurality of neural network layers may be optimized by the learning result of the artificial intelligence model. For example, during a learning process, the plurality of weight values may be updated such that a loss value or a cost value obtained from the artificial intelligence model is reduced or minimized. The artificial neural network may include a deep neural network (DNN). The artificial neural network may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the above-described example.

According to an embodiment of the present disclosure, a processor may implement artificial intelligence. The artificial intelligence may refer to an artificial neural network-based machine learning method that allows a machine to perform training by simulating human biological neurons. The methodology of artificial intelligence may be classified depending on a learning method as supervised learning, in which a solution (output data) to a problem (input data) is determined by providing input data and output data together as training data, unsupervised learning, in which only input data is provided without output data, and thus the solution (output data) to the problem (input data) is not determined, and reinforcement learning, in which a reward is given from an external environment whenever an action is taken in a current state, and thus learning progresses to maximize this reward. Moreover, the methodology of artificial intelligence may also be categorized depending on architecture, which is the structure of the learning model. The architecture of deep learning technology widely used may be categorized into convolutional neural networks (CNN), recurrent neural networks (RNN), transformers, and generative adversarial networks (GAN).

Each of the present device and the system may include an artificial intelligence model. The artificial intelligence model may be a single artificial intelligence model or may be implemented as a plurality of artificial intelligence models. The artificial intelligence model may be composed of neural networks (or artificial neural networks) and may include a statistical learning algorithm that mimics biological neurons in machine learning and cognitive science. The neural network may refer to a model as a whole having the ability to solve problems as artificial neurons (nodes), which form a network by connecting synapses, changes the strength of their synaptic connections through learning. Neurons in the neural network may include the combination of weight values or biases. The neural network may include one or more layers consisting of one or more neurons or nodes. For example, the present device may include an input layer, a hidden layer, and an output layer. The neural network constituting the present device may infer the result (output) to be predicted from an arbitrary input by changing a weight value of a neuron through learning.

The processor may create a neural network, may train or learn a neural network, or may perform operations based on received input data, and then may generate an information signal or may retrain the neural network based on the performed results. Models of a neural network may include various types of models such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) Network, and a classification network, but is not limited thereto. The processor may include one or more processors for performing computations according to the models of the neural network. For example, the neural network may include a deep neural network.

It will be understood by those skilled in the art that a neural network may include any neural network, but is not limited to a convolutional neural network (CNN), a recurrent neural network (RNN), a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

According to an embodiment of the present disclosure, the processor may use various artificial intelligence structures and algorithms such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) Network, a classification network, Generative Modeling, eXplainable AI, Continual AI, Representation Learning, AI for Material Design, algorithms for natural language processing (e.g., BERT, SP-BERT, MRC/QA, Text Analysis, Dialog System, GPT-3, and GPT-4), algorithms for vision processing (e.g., Visual Analytics, Visual Understanding, Video Synthesis, and ResNet), algorithms for data intelligence (e.g., Anomaly Detection, Prediction, Time-Series Forecasting, Optimization, Recommendation, and Data Creation), but is not limited thereto.

Hereinafter, an embodiment of the present disclosure will be described in detail with reference to the accompanying drawings.

The focus is on applying Mobile Edge Computing (MEC) and Fog Computing to various applications to enhance task offloading and resource allocation capabilities in existing services.

However, metaverse-based services required highly computationally intensive operations such as Augmented reality (AR) and virtual reality (VR) rendering on user equipment (UE), artificial intelligence activation for a non-player character (NPC), and data management for large-scale users, thereby making it difficult to satisfy requirements of the corresponding application.

To solve the issues, the present disclosure discloses applying COIN and Blockchain technologies. Here, the COIN is a shared environment where computing resources and services are connected and shared with each other via a network to provide complex services to users in a Metaverse service.

By incorporating the COIN paradigm, data reliability and security in offloading and resource allocation tasks may be ensured, and resource and service exchange between user terminals and server nodes may be easily implemented, thereby reducing the cost of offloading AI-based NPC. In this process, balancing memory, resource costs, and trust within the metaverse service is necessary.

In particular, the present disclosure discloses a method and system for optimizing offloading for applications and services in a COIN environment (i.e., a method and a system for a dynamic redundancy-aware blockchain-based Partial Computation Offloading (PCO) for Metaverse within a COIN environment).

In other words, the present disclosure relates to a method for effectively performing PCO based on blockchain to utilize unused network resources when computationally intensive applications and services, such as the Metaverse, are built and provided in a COIN environment, and more particularly, relate to a method and an algorithm that formulates Blockchain Redundancy Factor (BRF) and PCO problems by minimizing the computational cost and maximizing incentives within a Metaverse-based system, converts them into a real-time PCO problem based on temporal correlation and a Markov decision process-based BRF problem, designs a distributed algorithm for Nash equilibrium for the real-time PCO problem, and a Deep Double Q-network-based algorithm (DDQA) for the BRF problem to optimize offloading.

In this regard, this specification discloses a system and a method that may define a joint BRF and PCO problem to minimize computational cost, maximize incentives, and satisfy latency and blockchain offloading constraints, may transform the problem into two BRF sub-problems based on real-time PCO and Markov Decision Process (MDP), and may employ a distributed algorithm for the PCO problem and DDQA for the BRF problem, thereby significantly reducing cost overhead, providing higher rewards, and achieving optimal convergence within a few training episodes.

In the meantime, the present disclosure provides criteria for optimizing data replication in consideration of dynamic factors such as cross-shared communication overhead, shard allocation, blockchain cost arrangement, and overall offloading cost in providing the optimal BRF, and for allowing users to make optimal offloading decisions.

In this context, the present disclosure proposes a dynamic redundancy-aware blockchain-based PCO for Metaverse service operations of the COIN framework. The BRF is periodically updated based on demand calculations, costs, and price constraints to support PCO users.

Through these features, a user who derives the optimal BRF may make decisions based on the information guaranteed by the present disclosure to perform tasks within the Metaverse locally or remotely.

Moreover, a method and a system for dynamic redundancy-aware blockchain-based PCO for Metaverse within a COIN environment according to an embodiment of the present disclosure may place three layers when configuring servers and networks to enhance the QoS of Metaverse services, may not only perform traditional task offloading, but also performs optimal offloading through COIN agents by placing a high-performance computing and storage device, such as a COIN node and a cloudlet, and may provide an environment capable of providing scalable networks and ultra-low-latency services.

Furthermore, a method and a system for dynamic redundancy-aware blockchain-based PCO for Metaverse within a COIN environment according to an embodiment of the present disclosure may maximize incentives in a dynamic Metaverse service composed of EIN and FIN, and may present joint BRF and PCO problems occurring when performing COIN-based offloading, thereby minimizing the overhead of computational execution costs occurring when a user performs a task, while maximizing incentives and satisfying constraints on delay and blockchain offloading prices.

As described above, the BRF indicates redundancy in a blockchain. In the blockchain, data is stored in a distributed manner, and this distributed storage may increase the stability and reliability of data through the redundancy. The BRF is an indicator of the number of nodes within the blockchain network in each of which data is stored redundantly. In other words, the high BRF may increase the security of data, but may also impact the capacity and performance of a blockchain network.

In the meantime, the PCO problem relates to “Byzantine Fault Tolerance” which is one of the consensus algorithms in distributed computing environments. The PCO problem represents the challenge of reaching reliable consensus among nodes in a distributed system. It addresses issues arising from malicious or faulty nodes on a network, and addressing these issues is a crucial element in enhancing the security and reliability of distributed ledger technologies such as blockchain.

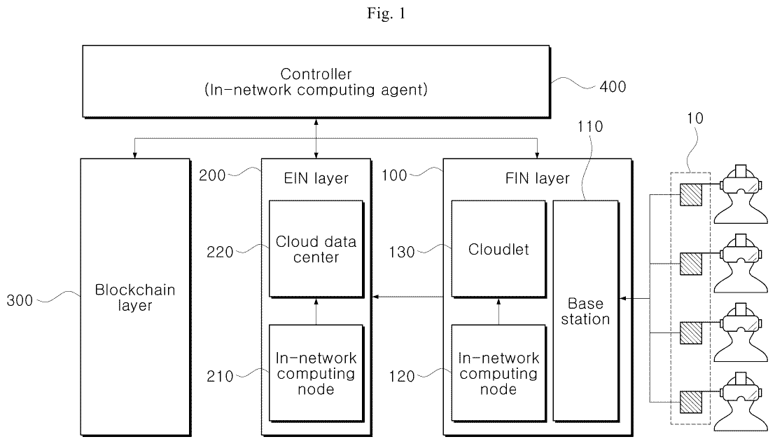

FIG. 1 is a block diagram of a dynamic redundancy-aware blockchain-based PCO system for Metaverse in a COIN environment, according to an embodiment of the present disclosure.

Referring to FIG. 1, a COIN system according to an embodiment of the present disclosure may include a User Equipment (UE) 10 and a COIN device that operates a metaverse service.

Here, the COIN device may include a plurality of layers, and a controller 400 that functions as a COIN agent.

The plurality of layers may include, for example, a first layer 100, a second layer 200, a third layer 300, and the like.

For convenience of description, the first layer 100 is referred to as a Fog COIN nodes (FIN) layer; the second layer 200 is referred to as an Edge COIN nodes (EIN) layer; and, the third layer 300 is referred to as a blockchain layer.

According to FIG. 1, to perform traditional task offloading, user requests collected through the user terminal 10 may be collectively received by a base station 110 at the FIN layer 100 to perform tasks within Metaverse.

Afterwards, the user data may be moved to COIN nodes 120 within the FIN layer 100.

The COIN nodes 120 may transmit user data to a cloudlet 130. Task offloading may be performed on the user data thus transmitted by the cloudlet 130.

The user data may be moved to the EIN layer 200 via the FIN layer 100.

After the user data is received by COIN nodes 210 within the EIN layer 200, the user data is transmitted to cloud data center 220, and task offloading may be performed by the cloud data center 220.

To perform task offloading according to an embodiment of the present disclosure, as described above, user requests collected through the user terminal 10 are collectively received by the base station 110 at the FIN layer 100 to perform tasks within the Metaverse, and then the user data is delivered to the EIN layer 200. Afterwards, task offloading may be performed based on the optimal offloading decision calculated by the controller 400.

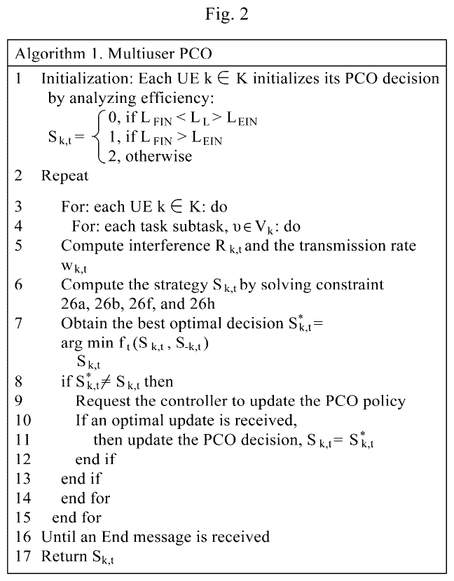

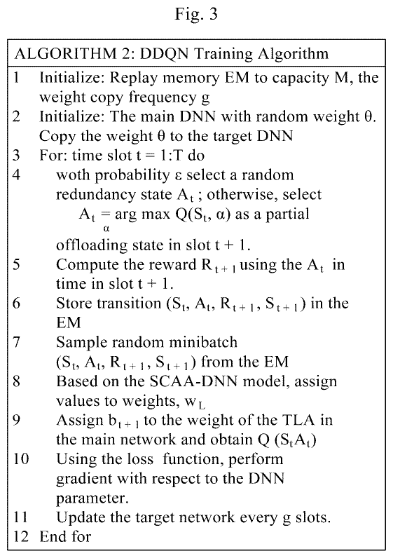

In this case, the controller 400 may ensure the privacy and security of the user data received through the blockchain layer 300, and may perform dynamic redundancy-aware blockchain-based PCO by considering and calculating the BRF based on algorithms of FIGS. 2 and 3 described below.

Moreover, in the present disclosure, due to the absence of transition probabilities for user requests, and interactions between PCO and BRF across various time slots, the problem may be defined by dividing it into the PCO problem and the BRF problem to address the issues.

FIG. 2 is a diagram for describing a distributed algorithm proposed to solve a PCO problem modeled in a form of an ordinal potential game (ODG) that allows multi-users to connect on a user side, according to an embodiment of the present disclosure.

Referring to the algorithm in FIG. 2, to solve the PCO problem of multiuser and ensure mutual user satisfaction, offloading decision may be first initialized based on computational efficiency, thereby inducing rapid convergence to an optimal solution. In the case of remote offloading, the aforementioned FIN and EIN efficiencies may be calculated as needed.

Afterwards, after calculating PCO for each user, and solving constraints 26a, 26b, 26f, and 26h in an iterative-execution loop to derive optimal PCO decision, the user may calculate inference and transmission rates for each subtask and may define a strategy space.

The constraints 26a, 26f, and 26h may guide the optimal PCO decision to minimize an objective function based on delay and power consumption. Afterwards, the user terminal 10 may request an update from the controller 400. In this case, when the user terminal 10 does not receive an update, the user terminal 10 may maintain the decision. When the user terminal 10 finally receives an END message, the user terminal 10 may offload the task.

FIG. 3 is a diagram illustrating an algorithm for training a Deep Double Q-Network (DQN), according to an embodiment of the present disclosure.

According to an algorithm of FIG. 3, an optimal redundancy level policy may be learned, for example, using DQN, to solve a BRF problem modeled by using a Markov decision process.

In this disclosure, a model is evaluated against several common criteria. The common criteria may include Overestimation Penalty for Generalization (OPG) with full redundancy, OPG with randomly assigned redundancy factors (OPG-Random), MEC with full redundancy, and random-based offloading (random) methods.

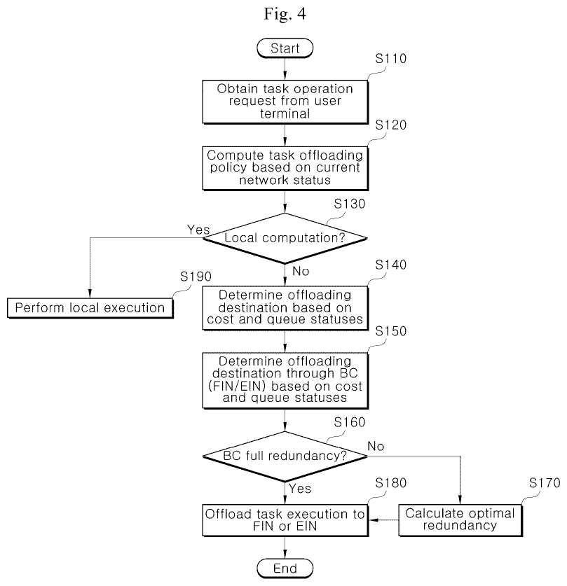

FIG. 4 is a flowchart illustrating an operating mechanism for each time slot in a system, according to an embodiment of the present disclosure.

FIG. 4 may illustrate, for example, an operating method performed by a system or the controller 400 of the system.

In operation S110, the controller 400 may obtain a task operation request from the user terminal 10.

In operation S120, the controller 400 may compute a task offloading policy based on a current network status.

In operation S130, the controller 400 may determine whether local computation is possible.

When the determination result of operation S130 indicates that the local computation is not possible, in operation S140, the controller 400 may determine an offloading destination based on cost and queue statuses.

In operation S150, the controller 400 may determine an offloading destination through a BC based on the cost and queue statuses. Here, the BC may represent, for example, FIN or/and EIN.

In operation S160, the controller 400 may determine BC full redundancy.

When the determination result of operation S160 does not indicate the BC full redundancy, in operation S170, the controller 400 may calculate optimal redundancy.

When the determination result of operation S160 indicates the BC full redundancy or/and optimal redundancy is calculated in operation S170, in operation S180, the controller 400 may offload task execution to the BC, i.e., FIN or EIN.

When the determination result of operation S130 indicates that the local computation is possible, in operation S190, the controller 400 may perform local execution.

Referring to FIG. 4, when a task is requested from the user terminal 10, the controller 400 may compute a task offloading policy based on a current network status, and may execute it at the corresponding layer when the corresponding computation is performed locally. On the other hand, when the corresponding computation is not performed locally, the controller 400 may determine an offloading destination from among the FIN layer 100, the EIN layer 200, and the blockchain layer 300 based on the cost and queue statuses.

In this case, a step of calculating the optimal redundancy factor depending on whether the redundancy of a blockchain is recognized may be performed, and the task offloading may be performed to the FIN layer 100 or the EIN layer 200.

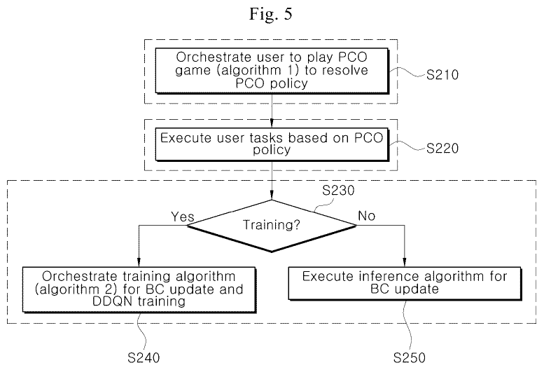

FIG. 5 is a diagram for describing an interaction between an algorithm and a system model, according to an embodiment of the present disclosure.

Referring to FIG. 5, in operation S210, the controller 400 may orchestrate the user terminal 10 to play a PCO game to resolve a PCO policy. The PCO game may be, for example, based on Algorithm 1 of FIG. 2. In the meantime, operation S210 may be performed, for example, at the start of time slot ‘t’.

In operation S220, the controller 400 may execute user tasks based on the PCO policy. Operation S220 may be performed, for example, during time slot ‘t’.

In operation S230, the controller 400 may determine whether training is performed.

In operation S240, when the training is performed, the controller 400 may orchestrate a training algorithm for BC update and DDQN training. In this case, the training algorithm illustrated in FIG. 3 may be used.

In operation S250, when the training is not performed, the controller 400 may execute an inference algorithm for the BC update.

Operations S230 to S250 may be performed, for example, at the end of time slot ‘t’.

Referring to FIG. 5, when time slot ‘t’ begins, the controller 400 may orchestrate user terminals to perform PCO, as in the algorithm illustrated in FIG. 2 to perform an PCO, and a task of the controller 400 may vary based on whether the training is performed, after a user's Metaverse task requests are executed based on the PCO policy.

When the training is performed, the controller 400 may orchestrate the training algorithm illustrated in FIG. 3 for the training of the DDQN and the update of a blockchain.

On the other hand, when the training is not performed, the controller 400 may perform an inference algorithm of the DDQN to update the blockchain.

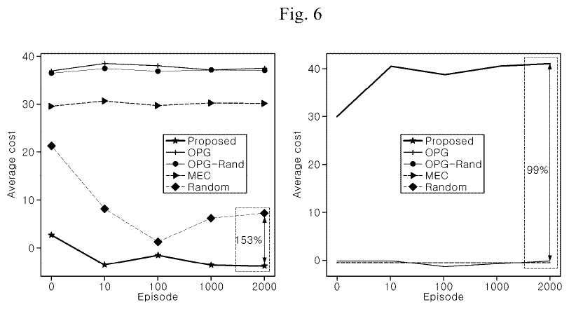

FIG. 6 is a diagram showing the progress of system cost and system reward for iteration steps according to various episodes, according to an embodiment of the present disclosure.

Referring to FIG. 6, the average cost and reward across various training episodes are evaluated compared to common criteria. As a result, the proposed model consistently has the lowest cost, followed by Random, MEC, OPG, and OPG-Ran models.

The proposed method shows that the average cost on the left side of FIG. 6 is reduced by 100% or higher compared to the Random method. In the average reward on the right side of FIG. 6, the proposed method achieves a higher system reward of 99% than the other methods.

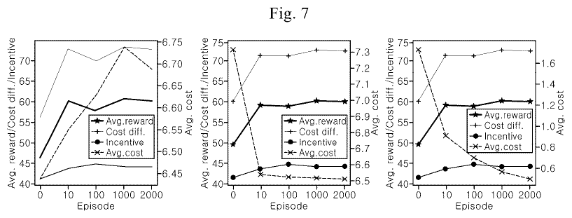

FIG. 7 is a diagram for comparing a reward function based on an average cost with OPG and OPG-Rand agents, according to an embodiment of the present disclosure.

Referring to FIG. 7, it is indicated that an agent's ability for learning optimal redundancy factor updates to reduce a cost and increase a reward.

To this end, the weighted sum of an incentive and the cost difference is selected as quantitative values of a reward to take the degree, to which costs are minimized and incentives are maximized by analyzing the reward function associated with the average cost, as a performance indicator. In this case, the incentive may be affected by a redundancy factor, and partial redundancy may reduce competition and may lower the overall reward.

Referring to FIG. 7, the OPG method may maximize incentives by reducing costs from full redundancy from the user's perspective, but it results in higher costs. Accordingly, the cost difference expands while the average cost increases.

The OPG-Ran method optimally allocates redundancy factors to reduce delay and overall system costs, thereby demonstrating that random assignment of redundancy factors effectively reduces overall system cost.

In relation to the method proposed in the present disclosure, first, subtask types within a Metaverse service are investigated and then tasks are classified into data-centric or computation-centric tasks. As a result, it may be seen that among six tasks, three are classified as data-centric tasks and three are computation-centric tasks, each of which consists of four sub-tasks.

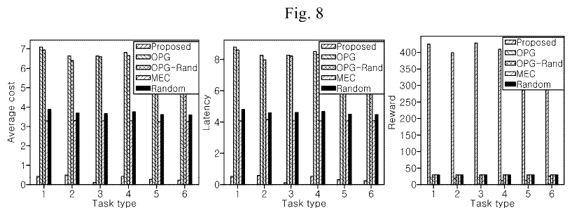

FIG. 8 is a diagram for comparing and describing impacts of computing task types on computational overhead according to an embodiment of the present disclosure, for each of average cost, average delay, and average reward.

According to FIG. 8, in terms of cost, a method according to an embodiment of the present disclosure demonstrates a cost reduced by 108% to 124% compared to the MEC model for data-centric tasks and a cost reduced by 111% to 119% for computation-centric tasks.

Moreover, because achieving very low latency in Metaverse is a critical indicator for ensuring QoS, the performance of the model is evaluated based on latency. As a result, the method according to an embodiment of the present disclosure demonstrates the reduction in latency of 109% to 124% for data-centric tasks and the reduction in latency of 111% to 119% for computation-centric tasks compared to the MEC model.

Furthermore, considering that delays in communication transmission primarily occur in data-centric tasks, while computation-centric tasks require additional delays, the controller 400 obtains approximately 100% higher average reward relative to the criteria, regardless of a task type.

Besides, in accordance with the method according to an embodiment of the present disclosure, second, the impact of a COIN parameter on computational cost may be evaluated through analysis across four aspects including a redundancy factor, the number of users, and the number of subtasks.

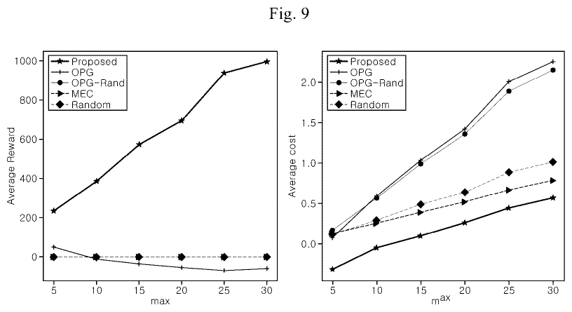

FIG. 9 is a diagram for comparing and describing the impact of the maximum redundancy factor for each time slot with respect to each of the average cost and average reward, according to an embodiment of the present disclosure.

FIG. 9 illustrates the average cost and reward for each time slot when a redundancy factor and the method of the present disclosure are changed.

In detail, as the redundancy factor increases, for example, from 5 to 30, the overall cost may increase by approximately 82%, and the cost of approximately 59% on average may be consistently reduced compared to MEC.

Moreover, the OPG and OPG-Ran methods not only significantly increase the cost compared to the proposed method, but also exhibit a higher reward reduction than the proposed method as the redundancy factor increases, for example, from 5 to 30. Accordingly, compared to state-of-the-art OPG solutions, optimal estimation of redundancy factors highlights the need for improving cost-effectiveness and reward in blockchain-based offloading projects.

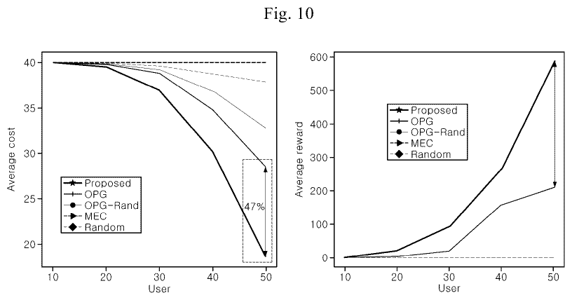

FIG. 10 is a diagram for describing an evaluation of the performance of each time slot for a set of various numbers of users according to an average cost and an average reward, according to an embodiment of the present disclosure.

FIG. 10 illustrates a performance evaluation of the proposed method when the number of users varies.

The method according to an embodiment of the present disclosure consistently demonstrates cost efficiency compared to the OPG method as the number of users increases.

In more detail, the method according to the present disclosure reduces the cost by approximately 47% compared to the OPG method. The OPG-Ran and Random methods also follow this cost reduction, and the cost of MEC remains stable as the number of users increases.

Furthermore, in terms of rewards, the method according to the present disclosure improved by about 64% for 20 users or more. In this way, it may be seen that the method according to an embodiment of the present disclosure is effective in reducing costs and maximizing rewards while determining the optimal offloading destination.

The present disclosure may also be implemented in a combination of two or more of the aforementioned embodiments.

The present disclosure provides the following effects.

First, to improve the QoS of a Metaverse service, it is possible to provide an environment that not only performs traditional task offloading but also performs optimal offloading through the COIN agent, and to provide a scalable network and ultra-low latency service.

Second, it is possible to maximize incentives and satisfy constraints on delay and blockchain offloading costs while minimizing the overhead of the operation execution cost occurring when a user performs a task.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A dynamic redundancy-aware blockchain-based Partial Computation Offloading (PCO) system for Metaverse in a COmputing In Network (COIN) environment, the blockchain-based PCO system comprising:
user equipment configured to transmit a request for a task of the Metaverse; and
a COIN device configured to operate a service of the Metaverse,
wherein the COIN device includes:
a plurality of layers, and
a controller configured to calculate a PCO and to send a request for determining a layer that performs a Metaverse task requested by the user equipment.

2. The blockchain-based PCO system of claim 1, wherein the plurality of layers include a first layer that receives user data including a task request sent from the user equipment, and performs first task offloading or sends the user data to a Metaverse service network.

3. The blockchain-based PCO system of claim 2, wherein the plurality of layers further include a second layer that receives the user data including the task request through the first layer, and performs the first task offloading or the PCO.

4. The blockchain-based PCO system of claim 3, wherein the plurality of layers further include a third layer that ensures the stability of data including a user request and guarantees privacy so as to identify an offloading policy for determining the PCO, and whether redundancy is recognized.

5. The blockchain-based PCO system of claim 1, wherein the user equipment performs a function of connecting to a Metaverse service built based on the COIN environment, and a function of transmitting a request for a Metaverse task and sub-tasks to a server and a network in the Metaverse service.

6. The blockchain-based PCO system of claim 1, wherein the controller performs a function of preemptively determining a redundancy factor of a blockchain to determine an offloading method, a function of defining policies of the Metaverse task, a function of measuring the redundancy factor of the blockchain where the requested Metaverse task is stored, and a function of controlling remote task commands within the system.

7. The blockchain-based PCO system of claim 2, wherein the first layer includes a base station configured to receive the user data transmitted from the user equipment, a COIN node capable of data communication with the controller or the base station, and a cloudlet configured to perform the first task offloading, and is a network layer capable of abstract or generalization.

8. The blockchain-based PCO system of claim 7, wherein the COIN node includes a function of receiving an offloading command from the controller, and delivering the PCO according to the user data, and a function of transmitting data based on a user request to the cloudlet, and is a node for a physical network device or a virtualized system.

9. The blockchain-based PCO system of claim 7, wherein the cloudlet includes a function of performing a Metaverse service request sent from the respective user device, and is a physical computation/storage device or a virtual machine-based system capable of complex computation.

10. The blockchain-based PCO system of claim 3, wherein the second layer includes a COIN node capable of data communication with the controller or the first layer and a cloud data center capable of performing the first task offloading, and is a network layer capable of abstract or generalization.

11. The blockchain-based PCO system of claim 10, wherein the COIN node is a node associated with a physical network device or a virtualized system that performs a function of receiving an optimal offloading command from the controller and delivering an optimal PCO according to the user data to the user equipment, and a function of transmitting data based on a user request to the cloud data center.

12. The blockchain-based PCO system of claim 10, wherein the cloud data center is a high-spec virtual machine-based system or a physical computation/storage device capable of complex computation that performs a request of a Metaverse task sent from pieces of user equipment.

13. The blockchain-based PCO system of claim 4, wherein the third layer is a network layer having, as components, a plurality of distributed databases that perform a function of encrypting the user data including a Metaverse task request of the user equipment, and a function of storing a transaction for a request of the user equipment.

14. A dynamic redundancy-aware blockchain-based PCO method for Metaverse in a COIN environment, the method comprising:
receiving a request for a task of the Metaverse from user equipment;
calculating a PCO through a plurality of layers; and
determining a layer that performs a Metaverse task requested by the user equipment.

15. The method of claim 14, wherein the plurality of layers include:
a first layer that receives user data including a task request sent from the user equipment, and performs first task offloading or sends the user data to a Metaverse service network.

16. The method of claim 15, wherein the plurality of layers include:
a second layer that receives the user data including the task request through the first layer, and performs the first task offloading or the PCO.

17. The method of claim 16, wherein the plurality of layers include:
a third layer that ensures the stability of data including a user request and guarantees privacy so as to identify an offloading policy for determining the PCO, and whether redundancy is recognized.

18. The method of claim 14, further comprising:
performing, through the user equipment, a function of connecting to a Metaverse service built based on the COIN environment, and a function of transmitting a request for a Metaverse task and sub-tasks to a server and a network in the Metaverse service.

19. The method of claim 14, further comprising:
performing a function of preemptively determining a redundancy factor of a blockchain to determine an offloading method, a function of defining policies of the Metaverse task, a function of measuring the redundancy factor of the blockchain where the requested Metaverse task is stored, and a function of controlling remote task commands within the system.

20. The method of claim 15, wherein the first layer is a network layer capable of abstract or generalization that receives the user data transmitted from the user equipment, and performs the first task offloading.
